(19) United States
(12) Patent Application Publication
(10) Pub. No.: US 2019/0111638 A1
(43) Pub. Date: Apr. 18, 2019

(54) COMPOSITE MATERIAL PART WITH METALLIC INSERT

(71) Applicants: PSA AUTOMOBILES S.A., Poissy (FR); FAURECIA AUTOMOTIVE COMPOSITE, Nanterre (FR)

(72) Inventors: LOUISE LEDAGUENEL, CINTRE (FR); PASCAL LIGOT, LE RHEU (FR); FABRICE REVEAU, BOURG DES COMPTES (FR); ERWAN TESSIER, SAINT MALO (FR); THIERRY RENAULT, DINARD (FR)

(21) Appl. No.: 16/158,884

(22) Filed: Oct. 12, 2018

(30) Foreign Application Priority Data
Oct. 13, 2017 (FR) 1759593

(51) Int. Cl. B29C 70/54; B29C 70/46; B29C 65/00; B26D 7/10; B26F 1/04

(52) U.S. Cl. CPC B29C 70/545; B29C 70/46; B26F 2001/4427; B26D 7/10; B26F 1/04; B29C 66/81425

(57) ABSTRACT

A method of manufacturing a composite part comprises placing a composite material part comprising fibers and a thermoplastic resin on a matrix; moving a presser towards the matrix in order to thermo-stamp the part; and making at least one orifice in the part by moving at least one punch through the part and at least one compactor pushing back the material of the part moved by the punch and forming a shoulder around the orifice or one of the orifices. This method also comprises a step of placing a metal insert on the shoulder of the or at least one of the orifices.

### CROSS-REFERENCE TO RELATED APPLICATIONS

This application claims priority to French App. No. 1759593 filed Oct. 13, 2017, which is incorporated herein by reference.

### BACKGROUND

This invention concerns the field of composite material parts, used chiefly in the automotive industry and designed to be assembled on a metal structure. More particularly, the invention concerns the production of composite material structural parts reinforced by short or continuous fibers held in a resin having thermoplastic properties.

New regulations impose on automotive designers a reduction in CO₂ emissions by 2020. Making vehicles lighter is proving to be the second most important lever to improve the energy efficiency of vehicles, after the first lever, which involves increasing engine performance.

In this sense, the constantly evolving technology of composite materials is used increasingly more in the automotive industry to produce multi-material, lighter, but also stronger structures, which enable the weight of the vehicle's components to be reduced by up to 40%. This is particularly the case with short-fiber reinforced thermoplastic materials currently present in numerous automotive parts such as, for example, front panels, technical parts under the hood, tailgates and rear floors. The same applies to continuous-fiber thermoplastic materials used to manufacture structural parts such as, among others, door reinforcements, seat structures or other bodies-in-white reinforcements. In both cases, these parts can be produced using different manufacturing processes based on composite material plates or preforms. However, among these processes, considering the nature and composition of the matrix material, a thermoforming or thermo-stamping process is frequently used.

Concerning more particularly the assembly of composite structural parts to metal structures or other elements that they are designed to reinforce, this assembly is achieved by means of openings or orifices made through the parts themselves, and that allow the passage of a fastening system such as a screw or rivet. This type of fastening also means, a fortiori, that orifices are also made in the metal structures supporting the structural parts and, depending on the shape of the parts in question, fitting these fastening systems may prove to be difficult and complicated. Ultimately this increases the assembly time of the part as well as its cost.

The formation of openings in the structural parts is usually performed after thermoforming the part during a so-called recovery step. These openings are usually made by cutting, specifically by high-pressure water jet, laser, punching or drilling. The cutting operations, in addition to being lengthy and tricky to perform due chiefly to the abrasive nature of composite materials, also have the drawback of cutting the continuous fibers that give the structural parts their strength. This, therefore, results in a weakening of the mechanical strength of the structural parts at their fixing orifices, as well as the difficulty of fitting them onto the metal structures.

In order to solve this problem, French Pat. No. 2926745A1 describes a method of making an orifice in a reinforced thermoplastic composite material part. The part in question is heated locally and the fibers of the composite material are gradually spread apart at the same time the matrix in the plastic state is radially pushed back to form firstly a starter hole that is then enlarged to the desired dimensions. When the hole is made, an operation to calibrate the thickness of the part in the hole area is performed, without removing material since the excess material is pushed back away from the hole. This device therefore has the advantage of enabling orifices to be made in composite material parts without damaging the fibers. It is also possible to enhance the reinforcement of the orifice by incorporating while drilling the part a metal ring around the orifice.

For its part, the French Pat. No. 3033521A1 describes a device and method of thermo-stamping a fiber-reinforced polymer-material composite plate. The device consists of a matrix and a punch designed to cooperate with the matrix and a drilling tool movably mounted in translation through the punch. During the thermo-stamping process, the composite plate is gripped between the punch and the matrix, while the drilling tool is driven in translation to pass through the pre-heated composite plate. On passing through the composite plate, the drilling tool parts the reinforcement fibers without breaking them and creates a through-hole while simultaneously carrying the pushed back projecting composite material onto the other face of the plate around the orifice. The matrix also comprises a movable tubular element in which the drilling tool engages so as to shape by pressure the pushed back projecting polymer material and form an edge that has the advantage of reinforcing the contour of the orifice. Although the region around the fixing orifices of the structural parts, as well as the orifices themselves can be reinforced by outgrowths of pushed back material and thus make the fixing of the parts more reliable, the fact remains that installing the fixing systems is not necessarily simplified and the assembly of composite material parts is time-consuming.

### SUMMARY

The object of the present invention is to overcome at least one of the drawbacks of the above-mentioned state of the art. More particularly, the object of the invention is to make the fixing of fiber-reinforced composite material parts onto metal structures, in this case motor vehicles, simpler and faster and thus also to reduce the time and cost of assembling these parts.

To this end, a method of manufacturing a composite part is disclosed comprising the following steps: placing a composite material part comprising fibers and a thermoplastic resin on a matrix; moving a presser towards the matrix in order to thermo-stamp the part; making at least one orifice in the part by moving at least one punch through the part and at least one compactor pushing back the material of the part moved by the punch and forming a shoulder around the orifice or one of the orifices. The method also comprises the following step: placing a metal insert on the shoulder of the or at least one of the orifices.

Advantageously, the composite material part is a preform.

Preferably, the composite material part is preheated before stamping and making at least one orifice in the part.

Advantageously, the material of the pushed back part is pushed back with the aid of a complex compactor provided with movable parts.

According to an advantageous embodiment, the shoulder around the orifice or at least one of the orifices forms a closed ring or several segments separated from one another, the corresponding insert being mechanically clamped in said ring or said segments, respectively.

According to an advantageous embodiment, at the step of fitting the metal insert(s), the or each of the inserts is moved solely towards the corresponding shoulder in an insertion movement.

According to an advantageous embodiment, for the or at least one of the orifices, the shoulder forms segments separated from one another and comprises radial notches, the corresponding insert having a peripheral edge with slots corresponding to the segments, and the step of fitting the metal insert comprises a movement of inserting the insert into the segments followed by a movement of rotating the insert so as to engage the peripheral edge of the insert in the notches.

According to an advantageous embodiment, the insert or each of the inserts is a plate with, around the periphery, a projection in contact with the corresponding shoulder. The face of the insert opposite the projection is aligned with the face of the part opposite the shoulder.

Advantageously, the diameter of the orifice or at least one of the orifices is more than 10 mm and/or less than 30 mm, and preferably on the order of 20 mm.

Advantageously, the external diameter of the shoulder is more than 30 and/or less than 40 mm, and preferably 33 mm.

Advantageously, the thickness of the shoulder is between at least 1.5 times and 2 times the thickness of the composite plate. The internal diameter of the shoulder can be between 25 and 35 mm, and preferably on the order of 30 mm.

According to an advantageous embodiment, the operation of fitting the metal insert(s) is performed when the part has a mean temperature of above 80° C. and/or below 120° C. Preferably the temperature is on the order of 100° C. (212° F.).

The invention also relates to a composite part comprising: a composite material thermo-stamped body comprising fibers and a thermoplastic resin, with at least one fixing orifice. The part also comprises: an insert housed in the or at least one of the fixing orifices, the body comprises, around said, orifice a shoulder with a bearing face of the insert, in the median plane of the part at the orifice, and one or more faces for positioning the insert, perpendicular to the bearing face.

The composite part is advantageously obtained by the claimed method.

According to an advantageous embodiment, the face(s) for positioning the shoulder or each of the shoulders form a closed ring or several segments separated from one another, clamping a peripheral edge of the insert.

According to an advantageous embodiment, the positioning faces of the shoulder or each of the shoulders form segments separated from one another with radial notches engaging with a peripheral edge of the insert.

The invention also relates to a motor vehicle comprising a metal structure and at least one composite part fixed to the metal structure. The composite part is in accordance with the claimed invention, the insert or each insert being fixed to the metal structure.

Advantageously, the fixing of the composite part onto the metal structure is achieved by welding the insert or inserts. Preferably, this is achieved by electrical spot welding.

Advantageously, the metal structure is a door of a motor vehicle, preferably a door liner, and the composite part is a reinforcement beam extending along the door, in this case along a face of the liner directed towards the outside of the vehicle.

The measures of the invention are interesting in that they enable structural parts of motor vehicles, such as reinforcement parts, to be fixed easily and quickly onto the metal elements that these parts must usually reinforce. This invention is interesting because the fixing of the parts by welding metal inserts tightly mounted inside the fixing orifices does away with any fastening system of the screw, bolt or rivet type which, in addition to being very voluminous, requires additional holes to be drilled that alter the visual appearance of the vehicle. Fitting metal inserts at the same time as the step of thermo-stamping a structural part, particularly creating an opening in the part, also enables a better insert/part connection and consequently further contributes not only towards reinforcing the contour of the orifice but also the orifice itself. This invention is all the more interesting because it can be extended to include other mechanical parts of the vehicle.

### DESCRIPTION OF THE DRAWING FIGURES

Further features and advantages will become clearer from the description and drawings, in which:

FIG. 1 is a schematic sectional view of a portion of a composite part according to a first embodiment;

FIGS. 2 and 3 show, respectively, a cross-sectional top view and a perspective view of the composite part of FIG. 1;

FIGS. 4 and 5 show a composite part according to a second embodiment;

FIGS. 6, 7 and 8 show a composite part according to a third embodiment;

FIG. 9 is a schematic sectional view of the composite part of FIG. 8;

FIGS. 10 and 11 show, respectively, a reinforcement of a motor vehicle door made of fiber-reinforced thermoplastic composite material, and the same reinforcement once fitted to the door of a vehicle.

### DETAILED DESCRIPTION

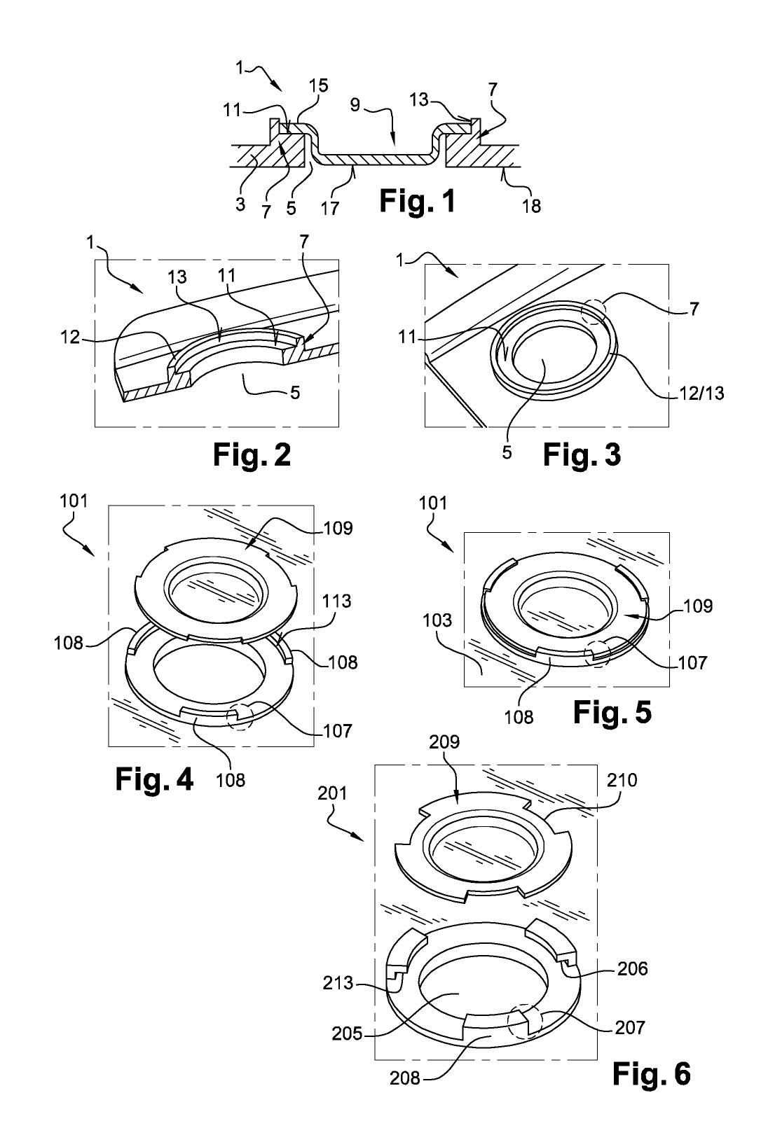

FIG. 1 is a schematic sectional view of a portion of a composite part 1 according to a first embodiment. This composite part 1 is manufactured in particular by thermo-stamping. This method comprises firstly placing in a mold (not shown) a part 3, preferably a prepreg, made of a composite material that comprises fibers and a thermoplastic resin on a matrix. A presser (not shown) then moves towards the matrix in order to thermo-stamp the part 3; then with the aid of a movable punch (not shown), one or more orifices 5 are made in the part 3. After the punch has passed through the part 3, at least one compactor (not shown) intervenes to push back the material displaced by the punch. This compacting has the effect of forming a shoulder 7, equivalent to a local extra thickness, around the hole(s) 5 so formed. These thermo-stamping steps are well known to a person skilled in the art.

Although FIG. 1 is a sectional view, it shows that in the first embodiment of the part 1, the shoulder 7 formed around the, or at least one of, the holes 5 in fact constitutes a closed ring in which the insert 9 is mechanically clamped. The shoulder 7 comprises in particular a bearing face 11 against which the insert 9 can abut, as well as a positioning face 13, the latter ensuring in particular the clamping of the insert 9.

The metal insert 9 itself comprises a metal plate, the shape of which corresponds to the geometry of the or at least one orifice 5. Thus, during the last step of the method of manufacturing the composite part 1, which comprises fitting the or each of the inserts 9 onto a shoulder 7 of the or at least one orifice 5, each insert 9 is moved solely towards the corresponding shoulder 7 in an insertion movement. The insertion movement in fact comprises a pressing movement in a direction perpendicular to the median plane of the part at the orifice, which allows the insert(s) 9 to be clamped into the corresponding shoulder 7. As shown in FIG. 1, the metal insert 9 is formed by a projection 15, which is in contact with the shoulder 7 of the composite part 3 concerned, while the face 17 of the insert 9 that is opposite this projection 15 is aligned with the face 18 of the part 3 opposite the shoulder 7.

FIGS. 2 and 3, respectively, show a cross-sectional top view, and a perspective view of the composite part 1 of FIG. 1. The insert 9 is intentionally omitted in these Figures so as to clearly show the closed ring shape 12 of the positioning face 13 of the shoulder 7, present around the orifice 5 of the part 3, as well as its bearing face 11.

FIGS. 4-5 and 6-9 show a composite part according to a second embodiment and a third embodiment, respectively. The reference numerals of the first embodiment are used here to designate the identical or corresponding elements, these numerals being increased by 100, however, for the second embodiment, and by 200 for the third embodiment. Reference is also made to the description of these elements within the context of the first embodiment. Specific reference numerals, comprised between 100 and 200 and 200 and 300 respectively, are used to designate specific elements.

The second embodiment, shown in FIGS. 4 and 5, is distinguished from the first embodiment basically in that the positioning face 113 of the shoulder 107 in the plane of the orifice 105 forms several segments 108 separated from one another. In this case in these Figures, the shoulder 107 comprises three segments 108. However, as with the first embodiment, the step of fitting the insert 109 onto the shoulder 107 of the orifice(s) 105 involves moving the insert 109 in an insertion direction perpendicular to the median plane of the parts at the orifice, so that the peripheral edge of the insert 109 is mechanically clamped with the segments 108. Advantageously, in this second embodiment, the peripheral edge of the metal plate forming the insert 109 has a shape that specifically matches the bearing face 111 of the shoulder concerned, so as to facilitate the clamped fitting of the insert 109.

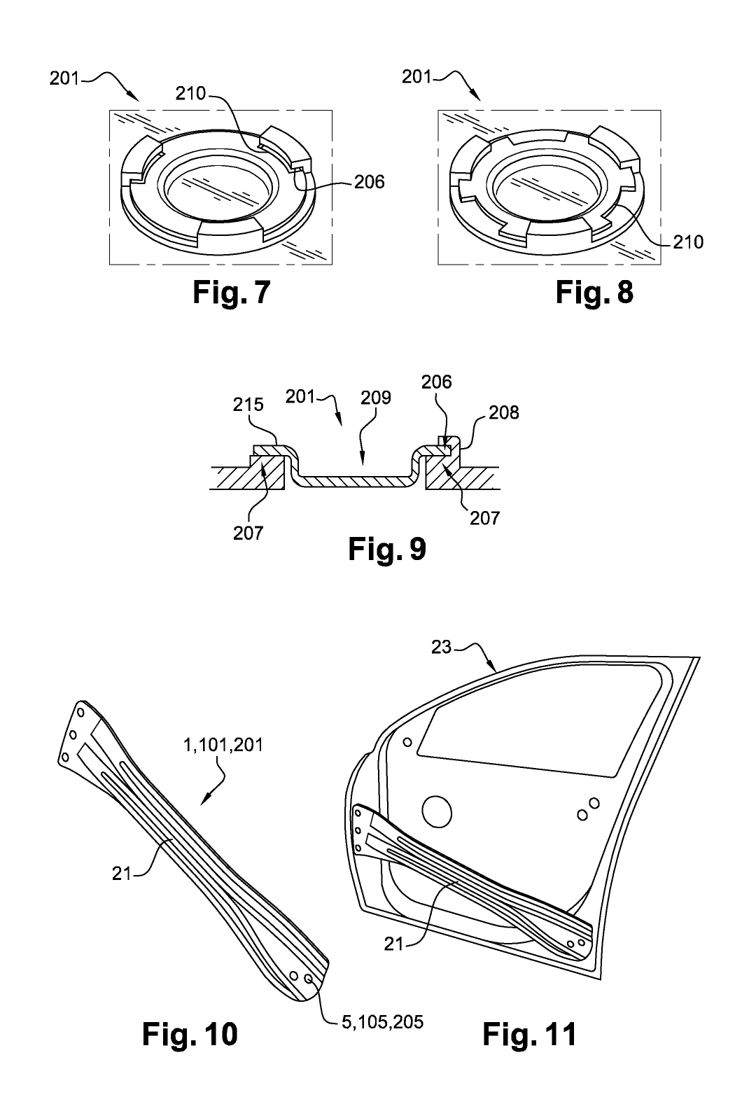

In the third embodiment, represented in FIGS. 6 to 9, the positioning faces 213 of the shoulder 207 or of each of the shoulders 207 concerned form segments 208 that are separated from one another and have radial notches 206. The corresponding insert 209 comprises a peripheral edge with slots 210 corresponding to the segments 208; the slots 208 engaging in the radial notches 206 of the segments 208 concerned. In this case, FIG. 6 shows an insert 209 with three slots and positioned over an orifice 205 having one shoulder 207 provided with three segments 208 with one radial notch 206 oriented towards the inside of the orifice 205. The step of fitting the insert in this embodiment also involves a movement of insertion, in a direction perpendicular to the median plane of the part at the orifice, of the insert 209 into the segments 208 (FIG. 7) but this insertion movement is then completed by a rotational movement of the insert 209 so as to be able to engage the peripheral edge of the insert 209 in the notches 206 of the segments 208 (FIG. 8).

FIG. 9 is a schematic cross-sectional view of the composite part 201 shown in FIG. 8. It shows in particular the peripheral edge of the insert 209 with the projection 215 when it is in contact with the shoulder 207 but also when it is engaged in a notch 206 of a segment 208 of a shoulder 207.

The method of manufacture of composite parts 1, 101, 201 according to the invention thus enables the creation of lightweight reinforced structural parts that are designed to be fixed, particularly to one or several structural elements of a motor vehicle. These structural parts 1, 101, 201 can take different forms, depending on the mold (matrix and presser) used for their manufacture but they always comprise a thermo-stamped body of composite material with a resin and preferably continuous fibers, and furthermore have at least one fixing orifice 5, 105, 205 in which will be housed a metal insert 9, 109, 209 which will serve to assemble them, for example by welding or any other means of fixing known to a person skilled in the art, to the bodywork or frame of a motor vehicle. This fixing orifice 5, 105, 205 is characterized in particular by the presence of a shoulder 7, 107, 207 around its contour. This shoulder 7, 107, 207 has a bearing face 11, 111, 211 as well as one or more positioning faces 13, 113, 213. In the first embodiment of the part 1 (FIGS. 1-3), the positioning face 13 of the shoulder 7 forms a closed ring 12; and in the second embodiment (FIGS. 4 and 5), the positioning faces 113 of the shoulder 107 form segments 108 separated from one another. However, in these two embodiments, the ring 12 is closed and the segments 108 have the function of clamping a peripheral edge of the insert (9, 109) so as to hold the insert (9, 109) fixed. In the third embodiment (FIGS. 6-9), the positioning faces 213 of the shoulder 207 form segments 208 separated from one another with radial notches 206, which after a rotational movement of the insert 209 engage with the peripheral edge of the insert 209 to hold it fixed in the orifice 205.

Advantageously, the fitting onto the shoulder 7, 107, 207 of the or at least one of the orifices 5, 105, 205, of a metal insert 9, 109, 209 is achieved advantageously when the part 3, 103, 203 has not yet cooled, in other words when the part 3, 103, 203 has a mean temperature on the order to 100° C., which enables better fixing of the metal insert 9, 109, 209 in the orifice 5, 105, 205 of the corresponding part 3, 103, 203.

FIG. 10 shows an example of a composite part 1, 101, 201, in this case it is a motor vehicle door reinforcement 21. This part is manufactured according to the manufacturing method described herein. Once the metal inserts 9, 109, 209 (not shown in FIG. 10) are fitted, clamped and locked in the corresponding formed orifices 5, 105, 205, the reinforcing part 21 is then fixed onto the vehicle door. FIG. 11 shows precisely the reinforcing part 21 of FIG. 10 after assembly by welding onto a face directed towards the outside of the vehicle of a door liner 23 of a vehicle.

Generally speaking, this method enables the fixing of structural parts, made of thermoplastic composite material reinforced by long, continuous fibers, onto the metal structures of motor vehicles to be simplified, and the assembly time of these parts and thus the cost thereof to be reduced. This thus has an economic potential because it can be replicated on any shape of thermoplastic composite parts to be fixed onto the metal structures of a motor vehicle, the assembly of the metal insert(s) of the orifices being achieved by any means of assembly, without affecting the body-in-white assembly process.

1. A method of manufacturing a composite part, comprising the following steps:
placing a composite material part comprising fibers and a thermoplastic resin on a matrix;
moving a presser towards the matrix in order to thermo-stamp the part;
making at least one orifice in the part by moving at least one punch through the part and at least one compactor pushing back the material of the part moved by the punch and forming a shoulder around the at least one orifice; and
placing a metal insert on the shoulder of the at least one orifice.

2. The method according to claim 1, wherein the shoulder around the at least one orifice forms a closed ring or several segments separated from one another; the corresponding metal insert being mechanically clamped in said ring or said segments, respectively.

3. The method according to claim 1, wherein at the step of fitting the metal insert, the insert is moved solely towards the corresponding shoulder in an insertion movement.

4. The method according to claim 1, wherein the shoulder of the at least one orifice forms segments separated from one another; the part comprising radial notches, and the corresponding insert has a peripheral edge with slots corresponding to said segments, and the step of fitting the metal insert comprises inserting said insert into said segments followed by rotating said insert so as to engage the peripheral edge of said insert in the notches.

5. The method according to claim 1, wherein the insert is a plate with, around the periphery, a projection in contact with the corresponding shoulder; the face of said insert opposite the projection being aligned with the face of the part opposite said shoulder.

6. The method according to claim 1, wherein the operation of fitting the metal insert is performed when the part has a mean temperature of above 80° and/or below 120° C.

7. A composite part comprising:
a composite material thermo-stamped body comprising fibers and a thermoplastic resin, with at least one fixing orifice; and
a metal insert housed in the at least fixing orifice, the body comprising around said orifice a shoulder with a bearing face of the insert, in the median plane of the part at the orifice, and one or more faces perpendicular to the bearing face for positioning said insert.

8. The composite part according to claim 7, wherein the one or more faces for positioning the insert form a closed ring or several segments separated from one another, clamping a peripheral edge of said insert.

9. The composite part according to claim 7, wherein the one or more faces for positioning the shoulder or each of the shoulders form segments separated from one another with radial notches engaging with a peripheral edge of said insert.

10. A motor vehicle comprising a metal structure and at least one composite part of claim 7 fixed to said metal structure; the insert or each insert being fixed to the metal structure.
